(19) United States
(12) Patent Application Publication
(10) Pub. No.: US 2017/0097295 A1
(43) Pub. Date: Apr. 6, 2017

(54) METHOD FOR DETERMINING SUSPENDED MATTER LOADS CONCENTRATIONS IN A LIQUID

(71) Applicant: Universite Libre De Bruxelles, Bruxelles (BE)

(72) Inventors: Michel Verbanck, Bruxelles (BE); Dragana Petrovic, Leuven (BE); Jean-Pierre Vanderborght, Bruxelles (BE)

(73) Assignee: Universite Libre De Bruxelles, Bruxelles (BE)

(21) Appl. No.: 15/381,179

(22) Filed: Dec. 16, 2016

Related U.S. Application Data
(63) Continuation of application No. 14/002,236, filed on Aug. 29, 2013.

(51) Int. Cl. G01N 15/06; G01F 23/22; G01N 9/36; G01L 9/08; G01N 7/00

(52) U.S. Cl. CPC G01N 15/06; G01L 9/08; G01N 7/00; G01N 9/36; G01F 23/22

(57) ABSTRACT

Systems, methods and kits monitor suspended matter loads concentration in a liquid. The systems, methods and kits collect environmental variables, comprising the pressure p at a depth L in said liquid and the liquid depth L at which said pressure p is collected to provide the value of the pressure p0 which is the aerial pressure. The systems, methods and kits further insert said environmental variables in an equation and calculate the suspended matter loads volumetric concentration in the liquid from the absolute pressure p measured at the depth L in the liquid.

This application is a continuation application of U.S. Ser. No. 14/002,236, filed Aug. 29, 2013, which is a 371 application of PCT/EP2012/054135 filed Mar. 9, 2012, which claims foreign priority benefit under 35 U.S.C. §119 of European Application Nos. 11157554.4 filed Mar. 9, 2011 and 11161020.0 filed Apr. 4, 2011.

### TECHNICAL FIELD

The present invention relates generally to the field of quantification of suspended matter loads concentrations in a liquid, and more particularly, to the quantification of suspended matter loads at high concentrations.

### BACKGROUND OF THE INVENTION

Knowing quantity of suspended sediment in various open flow channels is an economic and environmental interest. Indeed, particles transported in water, and the contaminants which are attached to them, are responsible of physical, chemical and biological damages. Sediments are one of the most widespread pollutants affecting numerous countries all over the world. Management and environmental protection of open channel flows require determining quantitatively the amount of suspended matter loads in water. In addition, suspended matter loads concentrations in a liquid may vary over time. Traditional gravimetric technique for determination of suspended matter loads relies on direct manual collection of samples and is affected by numerous limitations such as not continuous monitoring, dependence on site accessibility, climatic conditions. There exist many different surrogate methods to experimentally determine concentrations of suspended matter loads in water such as acoustic backscatter, bulk optic (turbidity), laser diffraction, pressure difference, vibrating tube (Gray et al., Water Resources Research, 2009, 45, WooD29).

Current methods may be either totally ineffective or very difficult to implement under some conditions, especially when the suspended sediment concentrations are high. Generally, known methods are suitable to determine low concentration of suspended matter loads when said concentration is less than 0.5% in volumetric concentration, but unsuitable when concentration is higher. To avoid signal saturation, optic-based methods such as absorptiometry or nephelometry would need, at these concentrations, an optical measurement length so short that it loses any capacity of representing the actual system. At high suspended matter concentrations, problems of accuracy and reliability of measured data can also appear. This is particularly pronounced in field applications where data readings can be influenced by the natural composition of suspended matter, typically under the form of changes in particle size distribution or in particle darkness properties. The latter shortcomings are well documented in turbidity based methods but also affect other principles of measurement (Gray et al., Water Resources Research, 2009, 45, WooD29). In addition to this, turbulent conditions generally create signal noise which makes interpretation difficult.

U.S. Pat. No. 6,687,643 discloses a sensor measuring the density of a liquid with pressure sensors. Said sensors measured pressure in a liquid at two separate positions defined by a fixed distance. The device further comprises a temperature sensor.

The existing densimetric method for monitoring suspended sediment concentrations is based on pressure difference monitoring. This differential technique has shown good accuracy in laboratory conditions for determining mass concentrations of suspensions of glass microspheres (Lewis et al., J. Environ. Qual., 1999, 28, 1490-1496). In field conditions, this technique was tested to measure the density of a water-sediment mixture (Larsen et al., Proc. of the 7^{th} Federal Interagency Sedimentation Conference, 2001). The signal obtained was difficult to interpret due to high level of noise introduced by turbulence. Tollner and co-workers (Tollner et al, J. Hydraul. Eng., December 2005, 1141-1144) confirmed that the monitoring of suspended sediment concentrations based on pressure difference measurement remains unreliable in the field conditions where bed form movement and large sediment objects are present. The fact that the upper point of pressure measurement needs necessarily to remain immersed in all circumstances also prevents the differential method to be implemented satisfactorily in an environment characterized by significant water-depth changes, such as in a river. In addition to this, selecting a vertical distance between the two pressure sensors of a too limited extent (in an effort aimed at circumventing the issue above) has inevitably the effect of strongly deteriorating the quality and representativeness of the signal.

Current pressure difference methods do not estimate suspended matter loads concentrations in the whole depth of rivers, which can lead to inaccuracy measurements and uncertainty of real suspended matter loads concentrations in case of spatial variation of suspended matter loads concentrations in the whole depth. All existing methods for suspended sediment measurements suffer for certain limitations and there exist no universal technique for monitoring at all flow and sediment transport conditions.

As example, in patent application EP1167947, a differential pressure measurement method is disclosed. The measure of the average density of the liquid is based on pressure difference readings between two immersed pressure sensors. Both sensors need to be immersed in water. The upper sensor has to be submerged at all time. In addition, the pressure sensors measure a differential pressure in a selected and limited distance of the water depth. This intrinsically limits the sensitivity of the differential-pressure method because of the limited weight of heavy fluid taken into consideration. Measuring too locally also degrades the representativeness of the signal because turbulent resuspension of the heavy particles is a process known to be very heterogeneous spatially. With such method, the real suspended-matter load is not estimated in the whole depth of the water and the noise characteristic of the turbulent puffs generally present in the flow severely affects the quality and representativeness of the measurements.

The differential pressure measurement of suspended matter loads is also unreliable in field conditions where bed form movement and large sediment objects are present.

There is a need for accuracy and reliable data to quantify the suspended matter loads content in the whole depth of a liquid.

### SUMMARY OF THE INVENTION

The present invention aims at providing a method for determining the suspended matter loads volumetric concentration in a liquid, in particular at high concentration. The present invention aims at providing an accurate measurement of the suspended matter loads based on an absolute pressure measurement instead of differential pressure measurement. The measurement may be performed with a single immersed pressure sensor. The determination of suspended matter loads volumetric concentration at regular intervals allows detecting high-concentrated suspended matter loads in the liquid. The present invention aims at providing continuous or semi-continuous quantification of suspended matter loads volumetric concentrations, especially in the high-concentration ranges experienced, for example, in some irrigation channels and rivers draining areas with severe loamy-soil erosion.

According to a first aspect of the present invention, the invention provides a method for determining suspended matter loads volumetric concentration in a liquid, wherein said method comprises the steps of:
a) collecting environmental variables comprising:
the pressure p at a depth L in said liquid,
the liquid depth L at which said pressure p is collected, and
providing the value of the pressure p0 which is the aerial pressure
b) inserting said environmental variables in an equation,
c) calculating the suspended matter loads volumetric concentration in the liquid. The aerial pressure p0 can be either the pressure above the liquid or the atmospheric pressure. The measure of the pressure p0 can be omitted in case of constant atmospheric pressure conditions prevailing above the liquid. Then, a known value of the atmospheric pressure may be used in step b) and c) of the present method.

In a preferred embodiment, the suspended matter loads volumetric concentration in the liquid is calculated from the absolute pressure p measured at depth L in the liquid (step c) of the method).

Hence, the present method for determining suspended matter loads volumetric concentration in a liquid comprises the steps of:
a) collecting environmental variables comprising:
the absolute pressure p at a depth L in said liquid,
the liquid depth L at which said pressure p is collected, and
providing the value of the pressure p0 which is the aerial pressure,
b) inserting said environmental variables in an equation,
c) calculating the suspended matter loads volumetric concentration in the liquid from the absolute pressure p measured at the depth L in the liquid.

The present method allows the measurement of the suspended matter loads volumetric concentration in environmental conditions where the level of the liquid changes. The present method allows such measurement with a single pressure sensor avoiding the risk that the pressure sensors remain outside the liquid. Indeed, when methods based on differential pressure are used, two pressure sensors are needed and both sensors should remain immersed in the liquid. This is incompatible in environmental conditions where the level of the liquid changes frequently due to natural hydrological cycles or human intervention. The present method is based on a single measurement of the absolute pressure p at a depth L in the liquid. Only this single sensor, which is immersed, is essential to provide a reliable and accurate measurement of the suspended matter loads concentration. Said immersed pressure sensor of the present invention may be disposed at any depth L of the liquid. Said immersed pressure sensor can be submerged very low having the free surface as the ultimate, upper boundary. In this way almost an ideal integration depth has been provided making use of a single sensor which by definition is better in terms of sensitivity and representativeness. Not having a second sensor closer to the water surface also prevents the risks of this second sensor being carried away by rapid flow, or being neutralized and damaged by rags or floatables, as can happen in the differential-pressure method.

In a preferred embodiment, the aerial pressure p0 above said liquid is collected as an environmental variable. The value of the pressure p0 may be measured above the liquid and further inserted in an equation (step b) of the method of the present invention. The measure of the pressure p0 above the liquid allows further enhancing the accuracy of the present method.

Hence, in a preferred embodiment, the present method may comprise the steps of:
a) collecting environmental variables comprising:
the aerial pressure p0 above said liquid,
the absolute pressure p at a depth L in said liquid,
the liquid depth L at which said pressure p is collected,
b) inserting said environmental variables in an equation,
c) calculating the suspended matter loads volumetric concentration in the liquid from the absolute pressure p at the depth L in the liquid measured in step a).

The present method may further comprise the step of collecting the temperature T of said liquid. The present method for determining the volumetric concentration of suspended matter loads is based on the measurements of physical parameters in a way to allow the semi-continuously or continuously monitoring of the suspended matter loads volumetric concentration. In particular, said method is suitable to determine the volumetric concentration of suspended matter loads even at high concentration of such loads in the liquid. Particularly, the method may determine suspended matter loads volumetric concentration in a liquid, wherein suspended matter loads mass concentration measured ranges from 5 kg/m³ to 100 kg/m³. The present method may be used in a highly variable water depth environment. The present method may allow an accurate determination of suspended matter loads. The present method provides a new suspended matter loads volumetric concentrations measuring tool. In particular, the liquid may be water, oil or derivatives thereof. The liquid may be in an open channel flow, an estuary, a river, an industrial conduit, an irrigation channel, an urban conduit, a sedimentation tank, a settling basin, a tank, a reservoir or any other liquid bodies container.

With the method of the present invention, high-resolution temporal records of suspended matter loads may be obtained. This method allows the records of the suspended matter loads concentration in the whole depth of a liquid using a single immersed pressure sensor. For example, the suspended matter loads may be suspended particles. For example, the suspended matter loads may be sediments, such as fine quartz sands.

According to a second aspect of the present invention, a kit of parts for the measurement of suspended matter loads volumetric concentration is provided. Said kit of part comprises a first pressure sensor able to measure the absolute pressure p at a depth in the liquid, a liquid-depth probe able to measure a liquid depth L above the first pressure sensor, and a software. Said first pressure sensor is an immersed sensor. Said first pressure sensor is configured to be disposed at the depth L in said liquid.

A second pressure sensor able to measure a pressure p0 above said liquid may also be provided. Said second pressure sensor is configured to be left outside the liquid.

Said kit may further comprise a temperature sensor able to measure the temperature T in the liquid. Said kit of parts further comprises a data management system. The data management system encompasses a data acquisition system such as data-logger. The data management system may comprise a processor, an encoding memory and one or more programs coupled to the processor. The data management system may be configured to perform the software. The software may be configured to perform the present method. Hence, said software may be configured to:
collect the measurements of environmental variables provided by the first pressure sensor, the liquid-depth probe, and optionally of the second pressure sensor left outside of the liquid, and optionally by a temperature sensor,
insert said measurements in an equation,
calculate and display said suspended matter loads volumetric concentration.

The suspended matter loads volumetric concentration may be calculated from the absolute pressure p measured at the depth L in the liquid. The data management system running the software may constantly acquire environmental variables. Alternatively, the data management system may store or record all environmental variables acquired over a time-integration period in order to be able to handle the observational records in a post-processing mode. This alternative may be considered when environmental changes affect the kit, for instance, momentarily deteriorate the quality of the signal of one of the sensors, but not affecting the others.

According to a third aspect of the present invention, an apparatus for the measurement of suspended matter loads volumetric concentrations in a liquid is provided. Said apparatus comprises a first pressure sensor for measuring a pressure p at a depth L in said liquid, a liquid-depth probe for measuring the depth L at which said first pressure sensor collects said pressure p, optionally a temperature sensor for measuring the temperature T in said liquid, also optionally a second pressure sensor for measuring a pressure p0 above said liquid, a software and a data management system able to perform said software, said software being programmed to:
collect the measurements of environmental variables provided by said first pressure sensor, said liquid-depth probe and optionally by said second pressure sensor and optionally by said temperature sensor,
insert said measurements in an equation,
calculate and display said suspended matter loads volumetric concentration. The software may calculate the suspended matter loads volumetric concentration from the absolute pressure p measured at the depth L in the liquid. Said first pressure sensor may be disposed at a depth L in the liquid. Said first pressure sensor is an immersed pressure sensor. Said second pressure sensor may be disposed above or outside the liquid. Said liquid-depth probe may be disposed above the liquid. Said liquid-depth probe may be an ultrasound probe or radar probe.

The apparatus measuring the volumetric concentration of suspended matter loads provides the instantaneous measurement of the value of the liquid depth

L in said liquid. It is therefore not necessary to add another limnimetric technique if, as is generally the case in environmental and process monitoring, liquid depth changes have to be recorded as well.

### BRIEF DESCRIPTION OF THE DRAWINGS

FIG. 1 represents a schematic view of the system for collecting and monitoring the suspended matter loads volumetric concentration according to an embodiment of the present invention.

FIG. 2a is a graphical representation of the suspended matter loads volumetric concentration (dynamic conditions), expressed in m³/m³ over a time-period.

FIG. 2b is a graphical representation of the observed versus known suspended sediment volumetric concentration in static conditions in a tank.

FIG. 3 represents a schematic view of a drilled tube in which a pressure sensor and a temperature sensor may be set.

### DETAILED DESCRIPTION OF THE INVENTION

According to a first aspect, the present invention relates to a method for determining suspended matter loads volumetric concentration in a liquid, wherein said method comprises the steps of:
a) collecting environmental variables comprising:
the absolute pressure p at a depth L in said liquid,
the liquid depth L at which said pressure p is collected, and providing the value of the pressure p0 which is the aerial pressure,
b) inserting said environmental variables in an equation,
c) calculating the suspended matter loads volumetric concentration in the liquid from the absolute pressure p measured at a depth L in the liquid.

The term “environmental variables” as used herein refers to parameters to be measured and essential to obtain an accurate volumetric concentration of the suspended matter loads.

The present method uses densimetric technique based on precise absolute pressure measurement for production of high-resolution temporal records of suspended matter loads. The method may be suitable for monitoring suspended matter loads volumetric concentrations at high concentrations. The method may be suitable to follow with high accuracy very turbid waters when the turbidity is created by very fine particles. Very fine particles may be clay and silt, or other particles of interest to the industry. The highest the concentration, the highest is the accuracy of the present method.

The volumetric concentration may be converted to the corresponding mass concentration of suspended matter loads in the liquid. Said mass concentration may be calculated by the multiplication of said volumetric concentration with the density of said suspended matter loads. The mass concentration of suspended matter loads may be expressed in kg/m³. Said mass concentrations in suspended matter loads may range from 0.25 kg/m³ to 1000 kg/m³. More preferably, said mass concentrations in suspended matter loads may range from 5 kg/m³ to 100 kg/m³.

The method comprises the measurement of a pressure at a depth in the liquid. The pressure measured at a depth in the liquid is noted “p” and is an absolute pressure. The liquid may be in a container or transported in an open channel. Preferably, the pressure in the liquid may be measured at a depth close to the channel or container bottom without interfering with it. The pressure p may be measured by a first pressure sensor. First pressure sensors can be any type of known pressure sensors having an accuracy better than 0.2% FS. The term “FS” means full-scale. Preferably, first pressure sensors may be of the piezo-electric type.

The method comprises the measurement of the liquid depth above the first pressure sensor. The measurement of the liquid depth may be determined with an ultrasound probe. Alternatively, the measurement of the liquid depth may be determined with a radar probe. The measurement of the liquid depth is noted “L”. The liquid depth probe may be fixed outside the liquid. Alternatively, the liquid depth probe may be fixed next to the first pressure probe.

The method may comprise the determination of the aerial pressure which can be the pressure above the liquid or the atmospheric pressure. Such determination can be made by any known method. In a preferred embodiment, the method may comprise the measurement of the pressure above the liquid. The pressure measured above the liquid is noted “p0”. In a more preferred embodiment, the pressure above the liquid may be the ambient atmospheric pressure. The pressure p0 may be measured by a second pressure sensor. Said second pressure sensor can be any type of known pressure sensors. The pressure p0 measured above said liquid is used for correction, permitting a more accurate value of the suspended matter loads concentration. In case of constant pressure conditions above the liquid, a known value of the aerial pressure is sufficient to implement the present method successfully. Thus, the measurement of the aerial pressure above the liquid can be omitted. However, the value of the aerial pressure p0 should be inserted in the equations in order to obtain the suspended matter loads volumetric concentration. In case of variable pressure conditions above said liquid, monitoring the pressure value p0 and inserting the value in an equation enable a more accurate measurement.

The method may comprise the measurement of the temperature of said liquid. The temperature of the liquid may be measured to determine the density of the liquid at said temperature. The measurement of the temperature is noted “T”. Temperature sensors can be any known temperature sensors. The temperature may be measured by the thermistor or the thermocouple principle. Preferably, the selected temperature measurement principle is the one already implemented and built-in in the immersible high-performance pressure transducer as described with respect to the first and second pressure sensor. Preferably, the temperature sensor is a thermocouple immersed in the liquid. Temperature sensor may be disposed at any distance apart the first pressure sensor. Preferably, the temperature sensor and the first pressure sensor are located close to each other.

The time resolution between two consecutive sets of measurements may be very short. In one embodiment, to avoid inaccuracy measurements of suspended matter loads when the liquid is in a dynamic system, like an open channel flow, environmental variables may be measured over a period of time suitable for integration, i.e. a time-integration period. The time-integration period may be at least 30 seconds. Preferably, the time-integration period may be 1 minute. Alternatively, the time-integration period may be longer than 1 minute. Values of each environmental variables inserted in the equation may be a linear average of values collected over the time-integration period. In a dynamic system, suspended matter loads concentration may be monitored semi-continuously. In another embodiment, when liquid is in a static system, values of each environmental variables may be a single value collected by the sensors and/or the probe. Preferably, the steps a) to c) of the present method may be repeatable at intervals of time of at least 30 seconds, preferably 1 minute. In a static system, suspended matter loads concentration may be monitored continuously. Thus, the present method may enable the following of the decantation of suspended matter loads.

The method may provide the measurement of the depth L above the first pressure sensor simultaneously with the measurement of said pressure p. The pressure p in the liquid varies with the liquid depth L. By simultaneously collecting the liquid depth L and the pressure p in the liquid, and compensating for changes in ambient aerial pressure, suspended matter loads volumetric concentration may be calculated with excellent accuracy.

The volumetric concentration of suspended matter loads is monitored using environmental variables previously measured. The volumetric concentration of suspended matter loads may be calculated according the following equation (I):

$$Cv = \frac{ρ w}{ρ s - ρ w} ( \frac{p - p 0}{gL ρ w} - 1 ) \qquad ( I )$$

wherein,

L is the depth at which said pressure p is collected, expressed in m,

p is the pressure at a depth L in said liquid, expressed in Pa,

p0 is the aerial pressure, expressed in Pa,

g is the gravitational acceleration, expressed in m/s²,

Cv is the suspended matter loads volumetric concentration, expressed in m³/m³,

ρs is the density of said suspended matter loads, expressed in kg/m³,

ρw is the density of said liquid at the temperature T, expressed in kg/m³.

Preferably, ρs may be the suspended sediment density. More preferably, if suspended sediment are quartz sands, ρs is 2650 kg/m³, which is the density of quartz. If suspended matter loads nature is unknown, ρs may be taken as equal to 2500 kg/m³. Alternatively, ρs may be determined by a known process.

The mass concentration Cw may be obtained by the equation (II):

Cw=Cv×ρs (II)

wherein,

Cw is the suspended matter loads mass concentration, expressed in kg/m³,

Cv is the suspended matter loads volumetric concentration, expressed in m³/m³,

ρs is the suspended matter loads density, expressed in kg/m³.

The pressure p0 may be considered as an environmental constant, like the medium ambient atmospheric pressure. The pressure p0 may also be considered as an environmental variable and be monitored with a pressure sensor placed above the liquid during the measurements of the depth L and the pressure p.

The liquid density ρw is slightly temperature dependent. Temperature in the liquid may be measured in order to determine the density of the liquid more exactly. The liquid density ρw may be calculated according to the following equation (III):

$$ρ w ( T ) = \frac{ρ w ( T 0 )}{1 + β ( T - T 0 )} \qquad ( III )$$

wherein,

ρw(T) is the density, expressed in kg/m³, of said liquid at the temperature T,

ρw(T0) is the reference density, expressed in kg/m³, of said liquid at known temperature T0,

β is the volumetric thermic expansion coefficient of the liquid, expressed in ° C.⁻¹,

T is the temperature of the liquid, expressed in ° C.,

T0 is the temperature at which the reference density of the liquid is known, expressed in ° C. T0 may be any temperature, since the ρw(T0) is known.

β is temperature dependent. β may be determined by an experimental determination using known method. β may be found in reference chemical property tables known in the art.

Alternatively, β may be calculated by an equation allowing an optimum accuracy of the value.

When the liquid is water, β, expressed in ° C.⁻¹, may be calculated using the following equation (IV):

β=10⁻⁶(−62.67914+15.84576T−0.11758T²) (IV)

wherein,

T is the water temperature, expressed in ° C.

For example, when the liquid is water and the temperature T=20° C., may be 0.000207° C.⁻¹.

When the liquid is not water, another equation has to be used in order to determine the exact value of β.

In applications such as industrial brines or the estuarine environment where the liquid may have high salinity, the method may be complemented by a local measurement of electrical conductivity, which allows to account for density changes attributable to the presence in significant amounts of dissolved ions. Electrical conductivity may be measured at the depth L where the pressure p is measured. Hence, the volumetric concentration of suspended matter loads in a liquid may be optionally calculated according the following equation (V):

$$Cv = \frac{ρ w ( T )}{ρ s - ρ w ( T )} ( \frac{p - p 0}{gL ρ w ( T )} - Cvsalt \frac{ρ salt - ρ w ( T )}{ρ w ( T )} - 1 ) \qquad ( V )$$

wherein,

L is the depth at which said pressure p is collected, expressed in m,

p is the pressure at a depth L in said liquid, expressed in Pa,

p0 is the pressure above said liquid, expressed in Pa,

g is the gravitational acceleration, expressed in m/s²,

Cv is the suspended matter loads volumetric concentration, expressed in m³/m³,

Cvsalt is the dissolved salt volumetric concentration, expressed in m³/m³,

ρs is the density of said suspended matter loads, expressed in kg/m³,

ρsalt is the density of salt, expressed in kg/m³,

ρw(T) is the density, expressed in kg/m³, of said liquid at the temperature T, expressed in ° C.

Cvsalt and ρsalt are either environmental variables or environmental constants. ρsalt may be found in reference chemical property tables known in the art.

Cvsalt and ρsalt may be calculated using known methods. For example, Cvsalt may be experimentally determined by the electrical conductivity measured in the liquid. In that case a conductivity probe may be added aside the first pressure sensor. Conversion of measured electrical conductivity into the value Cvsalt may rely on an assumption of the dominant salt effectively present. Salt effectively dominating brine composition or estuarine water composition may be NaCl. Standard open-channel applications can generally be treated neglecting the effect of dissolved salt.

In a preferred embodiment, the suspended matter loads volumetric concentration may be monitored in a real-time manner. Said concentration may be continuously or semi-continuously monitored.

As previously mentioned, the method of the present invention may be performed to monitor the volumetric concentration of suspended matter loads in a liquid. Said liquid may be in an open channel flow, an estuary, a river, an industrial conduit, an irrigation channel, an urban conduit, a sedimentation tank, a settling basin, a tank, a reservoir, or any other liquid bodies container. Preferably, said liquid may be in an open flow channel. Preferably, said liquid may be water, oil, derivatives or mixtures thereof. Said derivatives may be liquid residues from oil cracking. More preferably, said liquid may be water.

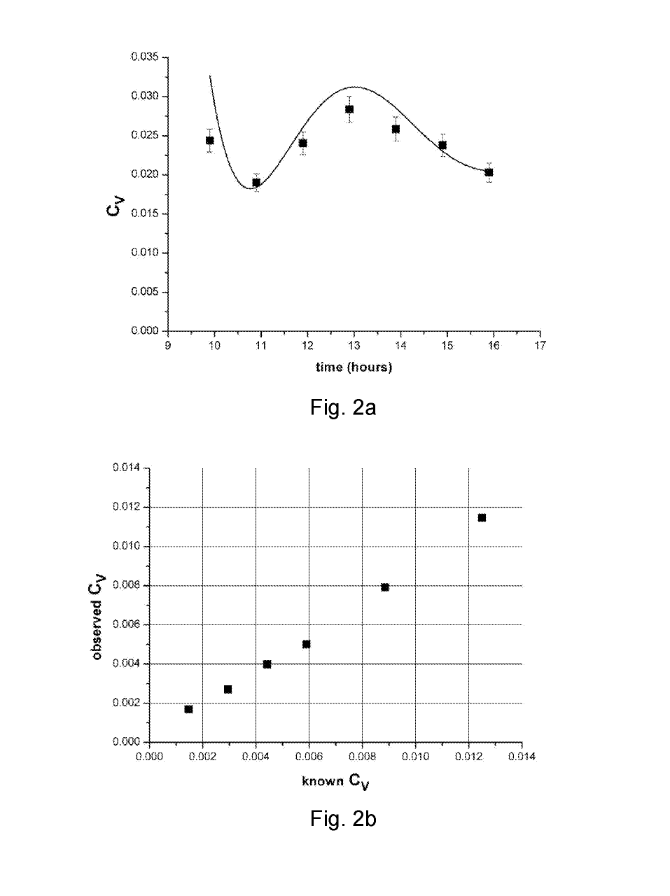

For example, a numerical model was done to control the applicability of the method (FIG. 2a). The dark squares represent the Cv determined by the method of the present application, together with the corresponding vertical error bar. The continuous curve represents a numerical simulation of fine evolution of Cv during a time-period. The results depicted in FIG. 2a are obtained using an immersed pressure sensor with an accuracy of 0.025% FS (full-scale). It is noted that, presently, pressure sensors of comparatively higher accuracy (0.010% FS) are already proposed on the market at reasonable price. Use of these modern, higher-performance pressure sensors would thus allow reducing even further the vertical error bars represented in the diagram. FIG. 2a provides thus a conservative estimate of what can be achieved nowadays when implementing the new suspended matter monitoring method.

The present method for determining the suspended sediment volumetric concentration was also applied in static conditions, such as in a tank. The testing was performed in laboratory conditions. The first pressure sensor was immersed at 0.27 m from the bottom of a 2.50 m deep tank. Water level was measured externally and kept constant at 2.00 m. Pressure above the liquid and temperature of the liquid were known and remained constant during the experiment. FIG. 2b represents the observed versus known suspended sediment volumetric concentration in these experimental conditions. Six different, known, volumetric concentrations of dry matter (density of 2710 kg/m³) were observed using the absolute pressure measurements. The results show a quite linear profile of the measurement which indicates that the present method is effective for determining the suspended sediment volumetric concentration in a liquid. The slight deviation observed was due to the relatively low volumetric concentrations. Indeed, the results may be influenced by accuracy of the pressure sensor and of the liquid-depth probe. At higher suspended sediment concentrations, the deviation will be less pronounced.

According to a second aspect of the present invention, a kit of parts is provided for measurement of suspended matter loads volumetric concentration. Said kit of parts comprises a first pressure sensor 11 able to be disposed at a depth L in the liquid and able to measure the absolute pressure p at said depth L in the liquid, a liquid-depth probe 8 able to measure a liquid depth L above the first pressure sensor 11 and a software able to perform the method of the present invention.

Said kit may further comprise a second pressure sensor 7 able to measure a pressure p0 above said liquid.

Said kit may further comprise a temperature sensor 12 able to measure a temperature T in a liquid.

Said kit of parts may further comprise a data management system 10. Said data management system 10 may comprise a processor and a memory encoding one or more programs coupled to the processor. In addition, said data management system 10 may be configured to perform software. Said software may be programmed to perform the following steps:
collect the measurements of environmental variables provided by said first pressure sensor 11, said liquid-depth probe 8 and optionally said second pressure sensor 7 and/or said temperature sensor 12,
insert said measurements in equations,
calculate and display said suspended matter loads volumetric concentration

The liquid-depth probe may be disposed above the liquid. Alternatively, the liquid-depth probe may be disposed at the surface of the liquid. Preferably, said liquid-depth probe may be an ultrasound probe or a radar probe or an image analysis probe disposed externally to the water flow. Disposing this probe externally may reduce risks of probe damage or fouling in high-concentration conditions.

Optionally said kit may comprise a probe for measuring the electrical conductivity of the liquid. As most of the conductivity probes also measure temperature, this option may allow eliminating the need of separate thermometer 12.

Alternatively, an assembly comprising a plurality of first pressure sensors 11, and of temperature sensors 12 may be provided. Hence, the concentration may be monitored at various points or depth in the liquid.

According to another aspect of the invention, the kit of parts of the present invention may be used for performing the present method for monitoring the suspended matter loads volumetric concentrations.

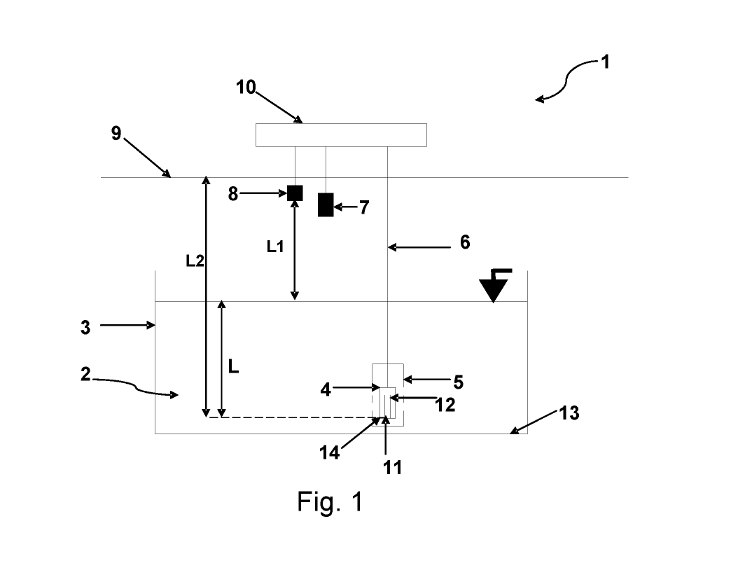

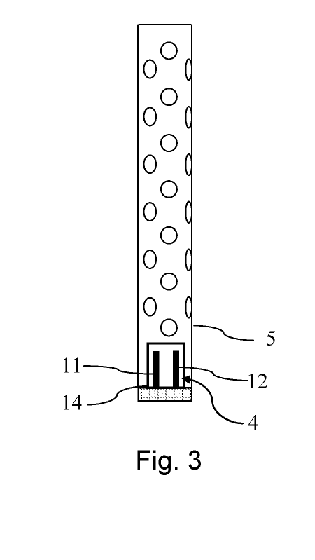

FIG. 1 represents a schematic view of the apparatus 1 for collecting and monitoring the suspended matter loads volumetric concentration in a liquid 2, such as water, in a container 3. For example, the container 3 may be an open flow channel, a river bed or a reservoir. The liquid temperature may be measured by a thermometer 12. The pressure p in the liquid may be collected by a first pressure sensor 11. Preferably, the first pressure sensor 11 and the temperature sensor 12 may be disposed at the same depth, close to each other. More preferably, the first pressure sensor and the temperature sensor may be provided within the measuring device 4. The pressure p0 above the liquid may be collected by a second pressure sensor 7. The measuring device 4 may comprise means for grounding 6. Said means for grounding 6 ensure the stability of the measuring device 4 in the liquid 2. Said means for grounding may be a cable affixed to a support 9 or a counterweight. Said support 9 may be an element overhanging the liquid. Said support may be a bridge or an element affixed on the top of a container 3. The measurement of the liquid depth may be collected with an ultrasound probe 8. In one embodiment, said ultrasound probe 8 determines the height L1 between said ultrasound probe 8 and the liquid. The cable 6 has a length L2. The liquid-depth L is determined by removing the height L1 from L2. The ultrasound probe 8 and the second pressure sensor 7 may be affixed to a horizontal support 9. In a preferred embodiment of the invention represented in FIG. 3, said measuring device 4 comprising the first pressure sensor 11 and the temperature sensor 12 may be hanged inside a vertical pipe 5 with holes drilled into it at regular intervals in order to reduce the effects of turbulence on the first pressure sensor 11. In a preferred embodiment, the upper side of the vertical pipe 5 is drilled at regular intervals and the lower side of the vertical pipe under the measuring device is netted like a grid in order to evacuate excessive amount of sediments which would have decanted within vertical pipe 5. The measuring device 4 is placed close to the liquid bed. The distance between the lower part 14 of the measuring device 4 and the bottom 13 of the container 3 is L′. Said distance L′ may range from 1 to 50 cm, preferably from 5 to 30 cm. The first pressure sensor 11 and the temperature sensor 12 communicate or are connected to the data management system 10. Furthermore, said data management system 10 is also connected or in communication with the second pressure sensor 7 and with the liquid-depth probe such as the ultrasound probe 8. All the probes may be fitted to a corresponding conditioner unit. The role of the conditioner unit is to perform the necessary amplification and primary filtering of the signal, as well as providing electric power to the transducer.

Alternatively, an assembly comprising a plurality of measuring devices 4 may be provided. Hence, the concentration may be monitored at various points or depth in the liquid. Each measuring device may independently communicate with the data management system 10. The method for determining the suspended matter loads volumetric concentration may be performed independently for each measuring device. Said assembly may further comprise one or more liquid-depth probes 8. Said assembly may further comprise one or more primary pressure sensors 11 in order to reduce the bias generated by strongly, turbulent, dynamic effects. Said one or more first pressure sensors 11 may be disposed at the same depth in the liquid. Each of said one or more first pressure sensors 11 measure an absolute pressure p. The average of each absolute pressure measured by each first pressure sensor is used in the present method.

### EXAMPLES

### Example 1

The present method is performed to monitor or determine the volumetric concentration of sediments in a river. The first pressure sensor is hung in a tube in order to be located near the bed of the river where suspended sediments volumetric concentration is to be measured. The temperature sensor is also hung in the tube, and is located next to the first pressure sensor. The liquid-depth probe is fixed on a bridge above the first pressure sensor and the temperature sensor. The second pressure sensor is located next to the liquid-depth probe.

The three sensors and the probe are connected to a data management system. Before measuring the suspended matter loads concentrations in the liquid, it is possible to input the environmental constants used in equations. Environmental constants are maximal expected water depth (allowing tuning electronic gain of the pressure transducer to improve measuring accuracy), suspended matter loads density, and reference water density at known temperature. The user inserts environmental constants into the software performed by the data management system as well as the periodicity of measurements (e.g. 30 seconds). Then, software performed by the data management system records environmental variables (p; p0; L; T) during 30 seconds. The data management system calculates the means of said variables over this period of time. Finally, software performed by the data management system inserts means calculated into the equation as presently described. The suspended sediment concentration is displayed.

### Example 2

The present method is performed to monitor the concentration of sediments in a tank or the density of the liquor contained in a tank. The first pressure sensor is fixed on the bottom of the tank where the suspended sediments volumetric concentration is to be measured. The temperature sensor is fixed next to the first pressure sensor. The liquid-depth probe is fixed underneath the roof of the tank, above the first pressure sensor and the temperature sensor. The second pressure sensor is located next to the liquid depth probe underneath the roof of the tank.

The three sensors and the probe are connected to a data management system. Before measuring the suspended matter loads volumetric concentrations in the liquid, it is possible to calculate the environmental constants used in the calculations. Environmental constants are suspended matter loads density; reference liquid density at known temperature. The user inserts environmental constants into the software performed by the data management system. There is no need to collect environmental variables over a period of time because of the non-dynamic state of the system. Then, data system management collects and records environmental variables (p; p0; L; T) in a real-time manner. Finally, the data system management inserts environmental variables into the equations to calculate and display the suspended sediment concentration.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated. As a consequence, all modifications and alterations will occur to others upon reading and understanding the previous description of the invention. In particular, dimensions, materials, and other parameters, given in the above description may vary depending on the needs of the application.

We claim:

1. A method of determining suspended matter loads volumetric concentration in a liquid, wherein said method comprises the steps of:
a) measuring environmental variables comprising:
the absolute pressure p at a depth L in said liquid, wherein absolute pressure p is measured by a single immersed pressure sensor disposed at the depth L in the liquid; and the liquid depth L at which said pressure p is measured by the single immersed pressure sensor wherein the liquid depth L is measured by a liquid-depth probe;
b) inserting, with a data management system, said measured environmental variables in an equation, wherein the single immersed pressure sensor and the liquid-depth probe are connected to the data management system, wherein the equation is:
$${C}_{v} = \frac{{ρ}_{w} ( T )}{{ρ}_{s} - {ρ}_{w} ( T )} ( \frac{p - {p}_{0}}{gL {ρ}_{w} ( T )} - {C}_{v salt} \frac{{ρ}_{salt} - {ρ}_{w} ( T )}{{ρ}_{w} ( T )} - 1 )$$
$$or$$
$${C}_{v} = \frac{{ρ}_{w} ( T )}{{ρ}_{s} - {ρ}_{w} ( T )} ( \frac{p - {p}_{0}}{gl {ρ}_{w} ( T )} - 1 )$$
wherein,
L is the depth at which said absolute pressure p is measured, expressed in m,
p is the absolute pressure measured at a depth L in said liquid, expressed in Pa,
p0 is aerial pressure, expressed in Pa,
g is gravitational acceleration, expressed in m/s²,
Cv is suspended matter loads volumetric concentration, expressed in m³/m³,
ρs is density of said suspended matter loads, expressed in kg/m³,
Cvsalt is dissolved salt volumetric concentration, expressed in m³/m³,
ρw(T) is density, expressed in kg/m³, of said liquid at the temperature T, expressed in ° C., and
ρsalt is density of salt, expressed in kg/m³; and
c) calculating, with the data management system, the suspended matter loads volumetric concentration in the liquid, via the equation from the measured absolute pressure p measured by the first pressure sensor at the measured depth L in the liquid measured by the liquid-depth probe.

2. The method according to claim 1, wherein the step of providing the value of the pressure p0 is performed by measuring the pressure above the liquid.

3. The method according to claim 1, wherein the temperature T of said liquid is collected and the density of the liquid is calculated according to the following equation:
$$ρ w ( T ) = \frac{ρ w ( T 0 )}{1 + β ( T - T 0 )}$$
wherein,
ρw(T) is the density, expressed in kg/m³, of said liquid at the temperature T,
ρw(T0) is the density, expressed in kg/m³, of said liquid at known temperature T0,
β is the volumetric thermic expansion coefficient of the liquid, expressed in ° C.⁻¹,
T is the temperature of the liquid, expressed in ° C., and
T0 is the temperature at which the reference density of the liquid is known, expressed in ° C.

4. The method according to claim 3, wherein the liquid is water and the volumetric thermic expansion coefficient is calculated according to the following equation:
β=10⁻⁶(−62.67914+15.84576T−0.11758T²)
wherein,
T is the temperature of the water, expressed in ° C.

5. The method according to claim 1, wherein suspended matter loads mass concentration, obtained from the suspended matter loads volumetric concentration, ranges from 0.25 kg/m³ to 1000 kg/m³.

6. The method according to claim 1, wherein the steps a) to c) are repeatable at intervals of time of at least 30 seconds.

7. The method according to claim 1, wherein the method is performed when the liquid is in an open channel flow, an estuary, a river, an industrial conduit, an irrigation channel, an urban conduit, a sedimentation tank, a settling basin, a tank, a reservoir, or other liquid bodies container.

8. A system for measuring suspended matter loads concentration in a liquid, the system comprising:
the liquid; and
an apparatus comprising:
a single immersed pressure sensor disposed at a depth L in the liquid and able to measure the absolute pressure p at said depth L in the liquid,
a liquid-depth probe disposed above the liquid and able to measure a liquid depth L above the single immersed pressure sensor, and
a data management system connected to at least the single immersed pressure sensor and the liquid-depth probe, wherein the data management system executes software programmed to:
a) collect the measured absolute pressure p and the measured liquid depth L measured by the first pressure sensor and the liquid-depth probe, and optionally a temperature sensor and an additional pressure sensor disposed above the liquid,
b) insert the measured absolute pressure p and the measured liquid depth L in an equation, wherein the software comprises the equation and the equation is:
$${C}_{v} = \frac{{ρ}_{w} ( T )}{{ρ}_{s} - {ρ}_{w} ( T )} ( \frac{p - {p}_{0}}{gL {ρ}_{w} ( T )} - {C}_{v salt} \frac{{ρ}_{salt} - {ρ}_{w} ( T )}{{ρ}_{w} ( T )} - 1 )$$
$$or$$
$${C}_{v} = \frac{{ρ}_{w} ( T )}{{ρ}_{s} - {ρ}_{w} ( T )} ( \frac{p - {p}_{0}}{gl {ρ}_{w} ( T )} - 1 )$$
wherein,
L is the depth at which said absolute pressure p is measured, expressed in m,
p is the absolute pressure at a depth L in said liquid, expressed in Pa,
g is gravitational acceleration, expressed in m/s²,
Cv is suspended matter loads volumetric concentration, expressed in m³/m³,
ρs is density of said suspended matter loads, expressed in kg/m³,
Cvsalt is dissolved salt volumetric concentration, expressed in m³/m³,
ρw(T) is density, expressed in kg/m³, of said liquid at the temperature T, expressed in ° C., and
ρsalt is density of salt, expressed in kg/m³; and
c) calculate, via the equation, and display said suspended matter loads concentration from the measured absolute pressure p measured by the first pressure sensor at the measured depth L in the liquid measured by the liquid-depth probe.

9. A kit of parts for the measurement of suspended matter loads volumetric concentration in a liquid comprising:
a single immersed pressure sensor able to be disposed at a depth L in the liquid and able to measure the absolute pressure p at said depth L in the liquid,
a liquid-depth probe able to measure a liquid depth L above the single immersed pressure sensor,
optionally an additional pressure sensor able to measure the pressure p0 above said liquid, and
software able to perform the method according to claim 1.

10. The kit of part according to claim 9, further comprising a temperature sensor configured to measure a temperature T in a liquid.

11. The kit of parts according to claim 9, further comprising a data management system.

12. The kit of parts according to claim 11, wherein the data management system comprises a processor, and a memory encoding one or more programs coupled to the processor.

13. The kit of parts according to claim 11, wherein said data management system is configured to execute the software in order to:
a) collect the measurements of the single immersed pressure sensor, the liquid-depth probe, and optionally, an additional pressure sensor and/or a temperature sensor,
b) insert said collected measurements in equations, and
c) calculate, via the equation, and display the suspended matter loads concentration.

14. The kit of parts according to claim 9, wherein the liquid-depth probe is an ultrasound probe or a radar probe.

15. The method according claim 1, wherein the absolute pressure p is measured by a single measure performed by the single immersed pressure sensor and the single immersed pressure sensor is the sole pressure sensor disposed or immersed in the liquid.

16. The method according to claim 1, wherein the aerial pressure p0 is measured by an additional pressure sensor and the temperature T of the liquid is measured by a temperature sensor, wherein the additional pressure sensor and the temperature sensor are connected to the data management system.

17. The method according to claim 16, wherein the single immersed pressure sensor is a piezo-electric type pressure sensor, the liquid-depth probe is selected from the group consisting of an ultrasound probe, a radar probe and image analysis probe, and the temperature sensor is a thermometer immersed in the liquid.
